(19) United States
(12) Patent Application Publication
(10) Pub. No.: US 2024/0341309 A1
(43) Pub. Date: Oct. 17, 2024

(54) HERBICIDAL COMPOSITIONS

(71) Applicant: SYNGENTA CROP PROTECTION AG, Basel (CH)

(72) Inventors: Philip Matthew JOYCE, Bracknell, Berkshire (GB); Joao Renato VAZ DA SILVA, Basel (CH)

(73) Assignee: SYNGENTA CROP PROTECTION AG, Basel (CH)

(21) Appl. No.: 18/577,391

(22) PCT Filed: Jul. 1, 2022
(86) PCT No.: PCT/EP2022/068247

§ 371 Date: Jan. 8, 2024

(30) Foreign Application Priority Data
Jul. 9, 2021 (EP) 21184832.0

(51) Int. Cl. A01N 47/06; A01N 31/14; A01N 37/02; A01N 37/06; A01N 37/10; A01N 37/22; A01N 43/40; A01N 43/80; A01P 13/00

(52) U.S. Cl. CPC A01N 47/06; A01N 31/14; A01N 37/02; A01N 37/06; A01N 37/10; A01N 37/22; A01N 43/40; A01N 43/80; A01P 13/00

(57) ABSTRACT

The present invention relates to a herbicidal composition comprising (A) a herbicidally effective amount of a compound of Formula (I), wherein G is selected from the group consisting of hydrogen, —C(O)CH₃ and —C(O)OCH₃; and (B) at least one herbicide selected from the group consisting of 2,4-D, clopyralid, dicamba, florpyrauxifen, fluroxypyr, halauxifen, triclopyr and 4-amino-3-chloro-5-fluoro-6-(7-fluoro-1H-indol-6-yl)pyridine-2-carboxylic acid including agrochemically acceptable esters or salts of any of the aforementioned (B) compounds. The present invention further relates to methods of controlling weeds comprising the herbicidal compositions of the invention.

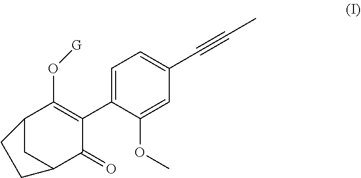

The present invention relates to novel herbicidal compositions comprising a combination of herbicidal active ingredients which provides control of weeds in crops of useful plants. The invention further provides methods of controlling weeds in crops of useful plants, and to the use of the herbicidal composition to control weeds. Compounds of Formula (I)

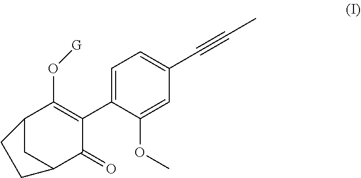

are known from WO2015/197468 and provide effective control of problematic weeds in crops. Combinations of herbicidal active ingredients are often used in agriculture to increase and/or broaden the control of problematic plants (weeds) in crops of useful plants. In some instances, the combination can give rise to a valuable greater-than-additive (synergistic) effect which can, for example, enable efficient weed control through lower application rates. The present invention is based upon novel compositions comprising compounds of Formula (I).

Thus, according to the present invention there is provided a herbicidal composition comprising (A) a herbicidally effective amount of a compound of Formula (I)

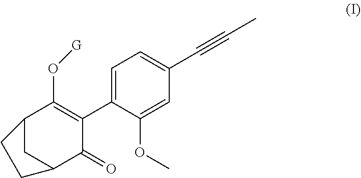

wherein G is selected from the group consisting of hydrogen, —C(O)CH₃ and —C(O)OCH₃; and (B) at least one herbicide selected from the group consisting of 2,4-D, clopyralid, dicamba, florpyrauxifen, fluroxypyr, halauxifen, triclopyr and 4-amino-3-chloro-5-fluoro-6-(7-fluoro-1H-indol-6-yl)pyridine-2-carboxylic acid including agrochemically acceptable esters or salts of any of the aforementioned (B) compounds.

In a preferred embodiment of the present invention the compound of Formula (I) is selected from the group consisting of Formula (Ia), (Ib) and (Ic).

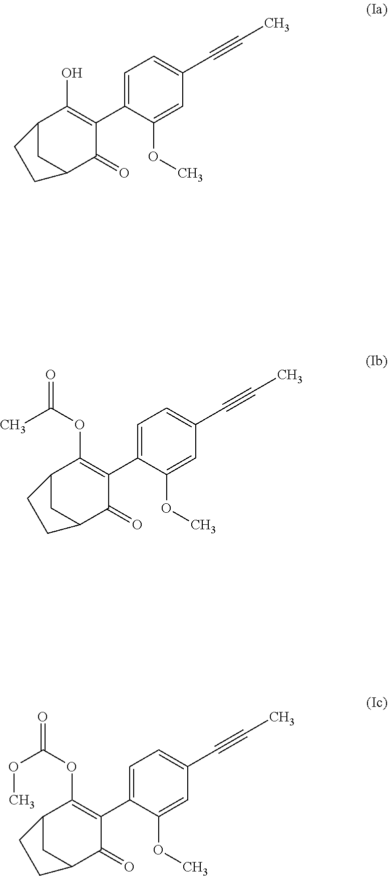

In one embodiment of the present invention the compound of Formula (I) is a compound of Formula (Ia)—including agrochemically acceptable salts thereof. In another embodiment of the present invention the compound of Formula (I) is a compound of Formula (Ib). In another embodiment of the present invention the compound of Formula (I) is a compound of Formula (Ic).

In one embodiment of the present invention component B is 2,4-D (B1). In this embodiment the 2,4-D may be in the form of an agrochemically acceptable ester or salt thereof including, but not limited to, the choline salt (B1a) and 2-ethylhexyl ester (B1b).

In another embodiment of the present invention component B is clopyralid (B2).

In another embodiment of the present invention, component B is dicamba (B3). In this embodiment the dicamba may be in the form of an agrochemically acceptable ester or salt thereof including, but not limited to the aluminium (B3a), aminopropyl (B3b), bis-aminopropylmethyl (B3c), choline (B3d), dichloroprop (B3e), diglycolamine (B3f), dimethylamine (B3g), dimethylammonium (B3h), potassium (B3i) and sodium (B3j) salts thereof.

In another embodiment of the present invention, component B is florpyrauxifen (B4) or florpyrauxifen-benzyl (B4a).

In another embodiment of the present invention, component B is fluroxypyr (B5).

In another embodiment of the present invention, component B is halauxifen (B6) or halauxifen-methyl (B6a).

In another embodiment of the present invention, component B is triclopyr (B7).

In another embodiment of the present invention, component B is 4-amino-3-chloro-5-fluoro-6-(7-fluoro-1H-indol-6-yl)pyridine-2-carboxylic acid (B8) or an agrochemically acceptable ester thereof, for example, methyl 4-amino-3-chloro-5-fluoro-6-(7-fluoro-1H-indol-6-yl)pyridine-2-carboxylate (B8a).

In another embodiment of the present invention the compound of Formula (I) is a compound of Formula (Ic) and component B is selected from the group consisting of 2,4-D (B1), dicamba (B3), florpyrauxifen (B4), fluroxypyr (B5), halauxifen (B6) triclopyr (B7) including agrochemically acceptable salts and/or esters of all of the previously mentioned compounds.

In a more preferred embodiment the present invention, the herbicidal composition comprises a mixture of components (A) and (B) as disclosed in Table 1 below.

TABLE 1

| Mixture | A | B | Mixture | A | B | Mixture | A | B |
|---|---|---|---|---|---|---|---|---|
| M1.001 | Ia | B1 | M2.001 | Ib | B1 | M3.001 | Ic | B1 |
| M1.002 | Ia | B1a | M2.002 | Ib | B1a | M3.002 | Ic | B1a |
| M1.003 | Ia | B1b | M2.003 | Ib | B1b | M3.003 | Ic | B1b |
| M1.004 | Ia | B2 | M2.004 | Ib | B2 | M3.004 | Ic | B2 |
| M1.005 | Ia | B3 | M2.005 | Ib | B3 | M3.005 | Ic | B3 |
| M1.006 | Ia | B3a | M2.006 | Ib | B3a | M3.006 | Ic | B3a |
| M1.007 | Ia | B3b | M2.007 | Ib | B3b | M3.007 | Ic | B3b |
| M1.008 | Ia | B3c | M2.008 | Ib | B3c | M3.008 | Ic | B3c |
| M1.009 | Ia | B3d | M2.009 | Ib | B3d | M3.009 | Ic | B3d |
| M1.010 | Ia | B3e | M2.010 | Ib | B3e | M3.010 | Ic | B3e |
| M1.011 | Ia | B3f | M2.011 | Ib | B3f | M3.011 | Ic | B3f |
| M1.012 | Ia | B3g | M2.012 | Ib | B3g | M3.012 | Ic | B3g |
| M1.013 | Ia | B3h | M2.013 | Ib | B3h | M3.013 | Ic | B3h |
| M1.014 | Ia | B3i | M2.014 | Ib | B3i | M3.014 | Ic | B3i |
| M1.015 | Ia | B3j | M2.015 | Ib | B3j | M3.015 | Ic | B3j |
| M1.016 | Ia | B4 | M2.016 | Ib | B4 | M3.016 | Ic | B4 |
| M1.017 | Ia | B4a | M2.017 | Ib | B4a | M3.017 | Ic | B4a |
| M1.018 | Ia | B5 | M2.018 | Ib | B5 | M3.018 | Ic | B5 |
| M1.019 | Ia | B6 | M2.019 | Ib | B6 | M3.019 | Ic | B6 |
| M1.020 | Ia | B6a | M2.020 | Ib | B6a | M3.020 | Ic | B6a |
| M1.021 | Ia | B7 | M2.021 | Ib | B7 | M3.021 | Ic | B7 |
| M1.022 | Ia | B8 | M2.022 | Ib | B8 | M3.022 | Ic | B8 |
| M1.023 | Ia | B8a | M2.023 | Ib | B8a | M3.023 | Ic | B8a |

In general, the mixing ratio (by weight) of the compound of Formula (I) to the compound of component B is from 0.01:1 to 100:1, more preferably from 0.025:1 to 20:1, even more preferably from 1:30 to 20:1. Thus, the preferred ratio ranges for preferred compositions of the invention are given in Tables 2 to 4 below. * Where component (B) exists in alternative forms (e.g salt/ester) then it should be understood that these can be substituted.

TABLE 2
Exemplar ratio ranges for specific compositions of the invention

| | Typical | Preferred | More Preferred |
|---|---|---|---|
| Mixture | Weight Ratio | Weight Ratio | Weight Ratio |
| M1.001 | 0.01:1 to 100:1 | 0.025:1 to 20:1 | 1:30 to 16:1 |
| M1.002 | 0.01:1 to 100:1 | 0.025:1 to 20:1 | 1:30 to 16:1 |
| M1.003 | 0.01:1 to 100:1 | 0.025:1 to 20:1 | 1:30 to 16:1 |
| M1.004 | 0.01:1 to 100:1 | 0.025:1 to 20:1 | 1:30 to 16:1 |
| M1.005 | 0.01:1 to 100:1 | 0.025:1 to 20:1 | 1:30 to 16:1 |
| M1.006 | 0.01:1 to 100:1 | 0.025:1 to 20:1 | 1:30 to 16:1 |
| M1.007 | 0.01:1 to 100:1 | 0.025:1 to 20:1 | 1:30 to 16:1 |
| M1.008 | 0.01:1 to 100:1 | 0.025:1 to 20:1 | 1:30 to 16:1 |
| M1.009 | 0.01:1 to 100:1 | 0.025:1 to 20:1 | 1:30 to 16:1 |
| M1.010 | 0.01:1 to 100:1 | 0.025:1 to 20:1 | 1:30 to 16:1 |
| M1.011 | 0.01:1 to 100:1 | 0.025:1 to 20:1 | 1:30 to 16:1 |
| M1.012 | 0.01:1 to 100:1 | 0.025:1 to 20:1 | 1:30 to 16:1 |
| M1.013 | 0.01:1 to 100:1 | 0.025:1 to 20:1 | 1:30 to 16:1 |
| M1.014 | 0.01:1 to 100:1 | 0.025:1 to 20:1 | 1:30 to 16:1 |
| M1.015 | 0.01:1 to 100:1 | 0.025:1 to 20:1 | 1:30 to 16:1 |
| M1.016 | 0.01:1 to 100:1 | 0.025:1 to 20:1 | 1:30 to 16:1 |
| M1.017 | 0.01:1 to 100:1 | 0.025:1 to 20:1 | 1:30 to 16:1 |
| M1.018 | 0.01:1 to 100:1 | 0.025:1 to 20:1 | 1:30 to 16:1 |
| M1.019 | 0.01:1 to 100:1 | 0.025:1 to 20:1 | 1:30 to 16:1 |
| M1.020 | 0.01:1 to 100:1 | 0.025:1 to 20:1 | 1:30 to 16:1 |
| M1.021 | 0.01:1 to 100:1 | 0.025:1 to 20:1 | 1:30 to 16:1 |
| M1.022 | 0.01:1 to 100:1 | 0.025:1 to 20:1 | 1:30 to 16:1 |
| M1.023 | 0.01:1 to 100:1 | 0.025:1 to 20:1 | 1:30 to 16:1 |

TABLE 3
Exemplar ratio ranges for specific compositions of the invention

| | Typical | Preferred | More Preferred |
|---|---|---|---|
| Mixture | Weight Ratio | Weight Ratio | Weight Ratio |
| M2.001 | 0.01:1 to 100:1 | 0.025:1 to 20:1 | 1:30 to 16:1 |
| M2.002 | 0.01:1 to 100:1 | 0.025:1 to 20:1 | 1:30 to 16:1 |
| M2.003 | 0.01:1 to 100:1 | 0.025:1 to 20:1 | 1:30 to 16:1 |
| M2.004 | 0.01:1 to 100:1 | 0.025:1 to 20:1 | 1:30 to 16:1 |
| M2.005 | 0.01:1 to 100:1 | 0.025:1 to 20:1 | 1:30 to 16:1 |
| M2.006 | 0.01:1 to 100:1 | 0.025:1 to 20:1 | 1:30 to 16:1 |
| M2.007 | 0.01:1 to 100:1 | 0.025:1 to 20:1 | 1:30 to 16:1 |
| M2.008 | 0.01:1 to 100:1 | 0.025:1 to 20:1 | 1:30 to 16:1 |
| M2.009 | 0.01:1 to 100:1 | 0.025:1 to 20:1 | 1:30 to 16:1 |
| M2.010 | 0.01:1 to 100:1 | 0.025:1 to 20:1 | 1:30 to 16:1 |
| M2.011 | 0.01:1 to 100:1 | 0.025:1 to 20:1 | 1:30 to 16:1 |
| M2.012 | 0.01:1 to 100:1 | 0.025:1 to 20:1 | 1:30 to 16:1 |
| M2.013 | 0.01:1 to 100:1 | 0.025:1 to 20:1 | 1:30 to 16:1 |
| M2.014 | 0.01:1 to 100:1 | 0.025:1 to 20:1 | 1:30 to 16:1 |
| M2.015 | 0.01:1 to 100:1 | 0.025:1 to 20:1 | 1:30 to 16:1 |
| M2.016 | 0.01:1 to 100:1 | 0.025:1 to 20:1 | 1:30 to 16:1 |
| M2.017 | 0.01:1 to 100:1 | 0.025:1 to 20:1 | 1:30 to 16:1 |
| M2.018 | 0.01:1 to 100:1 | 0.025:1 to 20:1 | 1:30 to 16:1 |
| M2.019 | 0.01:1 to 100:1 | 0.025:1 to 20:1 | 1:30 to 16:1 |
| M2.020 | 0.01:1 to 100:1 | 0.025:1 to 20:1 | 1:30 to 16:1 |
| M2.021 | 0.01:1 to 100:1 | 0.025:1 to 20:1 | 1:30 to 16:1 |
| M2.022 | 0.01:1 to 100:1 | 0.025:1 to 20:1 | 1:30 to 16:1 |
| M2.023 | 0.01:1 to 100:1 | 0.025:1 to 20:1 | 1:30 to 16:1 |

TABLE 4
Exemplar ratio ranges for specific compositions of the invention

| | Typical | Preferred | More Preferred |
|---|---|---|---|
| Mixture | Weight Ratio | Weight Ratio | Weight Ratio |
| M3.001 | 0.01:1 to 100:1 | 0.025:1 to 20:1 | 1:30 to 16:1 |
| M3.002 | 0.01:1 to 100:1 | 0.025:1 to 20:1 | 1:30 to 16:1 |
| M3.003 | 0.01:1 to 100:1 | 0.025:1 to 20:1 | 1:30 to 16:1 |
| M3.004 | 0.01:1 to 100:1 | 0.025:1 to 20:1 | 1:30 to 16:1 |
| M3.005 | 0.01:1 to 100:1 | 0.025:1 to 20:1 | 1:30 to 16:1 |
| M3.006 | 0.01:1 to 100:1 | 0.025:1 to 20:1 | 1:30 to 16:1 |
| M3.007 | 0.01:1 to 100:1 | 0.025:1 to 20:1 | 1:30 to 16:1 |
| M3.008 | 0.01:1 to 100:1 | 0.025:1 to 20:1 | 1:30 to 16:1 |
| M3.009 | 0.01:1 to 100:1 | 0.025:1 to 20:1 | 1:30 to 16:1 |
| M3.010 | 0.01:1 to 100:1 | 0.025:1 to 20:1 | 1:30 to 16:1 |
| M3.011 | 0.01:1 to 100:1 | 0.025:1 to 20:1 | 1:30 to 16:1 |
| M3.012 | 0.01:1 to 100:1 | 0.025:1 to 20:1 | 1:30 to 16:1 |
| M3.013 | 0.01:1 to 100:1 | 0.025:1 to 20:1 | 1:30 to 16:1 |
| M3.014 | 0.01:1 to 100:1 | 0.025:1 to 20:1 | 1:30 to 16:1 |
| M3.015 | 0.01:1 to 100:1 | 0.025:1 to 20:1 | 1:30 to 16:1 |
| M3.016 | 0.01:1 to 100:1 | 0.025:1 to 20:1 | 1:30 to 16:1 |
| M3.017 | 0.01:1 to 100:1 | 0.025:1 to 20:1 | 1:30 to 16:1 |
| M3.018 | 0.01:1 to 100:1 | 0.025:1 to 20:1 | 1:30 to 16:1 |
| M3.019 | 0.01:1 to 100:1 | 0.025:1 to 20:1 | 1:30 to 16:1 |
| M3.020 | 0.01:1 to 100:1 | 0.025:1 to 20:1 | 1:30 to 16:1 |
| M3.021 | 0.01:1 to 100:1 | 0.025:1 to 20:1 | 1:30 to 16:1 |
| M3.022 | 0.01:1 to 100:1 | 0.025:1 to 20:1 | 1:30 to 16:1 |
| M3.023 | 0.01:1 to 100:1 | 0.025:1 to 20:1 | 1:30 to 16:1 |

The skilled person will appreciate that the most preferred ratio range of A:B for any one of composition numbers M1.001 to M1.062, M2.001 to M2.062 and M3.001 to M3.062 described in Tables 2, 3 and 4 above is likely to be from 1:30 to 16:1, and that each ratio can be optimised depending on the mixture partners. Thus, approximate ratios of 1:30, 1:20, 1:10, 1:5, 1:4, 1:3, 1:2, 1:1, 2:1, 3:1, 4:1, 5:1, 10:1, 20:1 30:1 are also envisaged.

It should be further understood that the compositions of the present invention may further comprise one or more additional herbicidal active ingredient(s), thus providing 3-way, 4-way or even 5-way or more mixes. Thus, the composition of the present invention may contain more than one (B) component, for example two, three or four (B) components. For example, the composition may comprise (i) a compound of Formula I (especially Ic), (ii) 1 (or B1a or B1b) B1e) and (iii) B3 (e.g B3a, B3b, B3c, B3d, B3e, B3f, B3g, B3h, B3i, B3j, B3k, B3l and B3m). Alternatively, the composition may comprise (i) a compound of Formula (I), (ii) B2 (or B2a, B2b, B2c) and (iii) B3 (e.g B3a, B3b, B3c, B3d, B3e, B3f, B3g, B3h, B3i and B3j). In another embodiment of the invention the herbicidal composition further comprises one or more additional herbicidal component(s) (C). Component (C) can, for example, include glyphosate (or an acceptable salt thereof), glufosinate (or L-glufosinate) or acceptable salts thereof, an HPPD-inhibiting herbicide, an ACCase-inhibiting herbicide (e.g clethodim) or a VLCFA herbicide, especially those selected from the group consisting of acetochlor, metolachlor and S-metolachlor and pyroxasulfone, preferably S-metolachlor.

According to another aspect of the present invention there is provided a method of controlling weeds at a locus comprising applying to the locus of a weed controlling amount of a composition of the present invention.

In another embodiment of the present invention there is provided a method of selectively controlling weeds at a locus comprising crop plants and weeds, said method comprising applying to the locus a weed controlling amount of a composition according to the invention. In a preferred embodiment the crop plant is soybean. In this context, weeds could include, for example, volunteer maize (corn), including genetically-modified maize.

When applied in a composition of the invention component (A) is typically applied at a rate of 25 to 2000 g ha, more particularly 25, 50, 75, 100, 125, 150, 200, 250, 300, 400, 500, 750, 800, 1000, 1250, 1500, 1800, or 2000 g/ha. Such rates of component (A) are applied typically in association with 5 to 2000g/ha of component B, and more specifically in association with 5, 10, 15, 20, 25, 50, 75, 100, 120, 125, 140, 150, 200, 240, 250, 300, 400, 480, 500, 750, 1000, 1250, 1500, 1800, or 2000g/ha of component (B). The Examples described herein illustrate but do not limit the range of rates of components A and B that may be employed in the invention.

The amount of a composition according to the invention to be applied, will depend on various factors, such as the compounds employed; the subject of the treatment, such as, for example plants, soil or seeds; the type of treatment, such as, for example spraying, dusting or seed dressing; or the application time. In agricultural practice the application rates of the composition according to the invention depend on the type of effect desired, and typically range from 30 to 4000 g of total composition per hectare, and more commonly between 30 and 2000g/ha. The application is generally made by spraying the composition, typically by tractor mounted sprayer for large areas, but other methods such as dusting (for powders), drip or drench can also be used.

When active ingredients are combined, the activity to be expected (E) for any given active ingredient combination obeys the so-called Colby Formula and can be calculated as follows (Colby, S. R., Calculating synergistic and antagonistic responses of herbicide combination, Weeds, Vol. 15, pages 20-22; 1967):
ppm=milligrams of active ingredient (a.i.) per litre
X=% action by first active ingredient using p ppm of the active ingredient
Y=% action by second active ingredient using q ppm of the active ingredient.

According to Colby, the expected action of active ingredients A+B using p+q ppm of active ingredient is represented by the following formula:

$$E = X + Y - \frac{X \cdot Y}{100}$$

If the action actually observed (O) is greater than the expected action E then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

Accordingly, the combination of the present invention takes advantage of any additive herbicidal activity, and certain embodiments may even exhibit a synergistic effect. This occurs whenever the action of an active ingredient combination is greater than the sum of the actions of the individual components.

Combinations of the invention may also provide for an extended spectrum of activity in comparison to that obtained by each individual component, and/or permit the use of lower rates of the individual components when used in combination to that when used alone, in order to mediate effective herbicidal activity.

In addition, it is also possible that the composition of the invention may show increased crop tolerance, when compared with the effect of the compound A alone. This occurs when the action of an active ingredient combination is less damaging to a useful crop than the action of one of the active ingredients alone.

Throughout this document the expression “composition” should be interpreted as meaning the various mixtures or combinations of components (A) and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components (A) and (B) is not essential for working the present invention.

The term “herbicide” as used herein means a compound that controls or modifies the growth of plants. The term “herbicidally effective amount” means the quantity of such a compound or combination of such compounds that is capable of producing a controlling or modifying effect on the growth of plants. Controlling or modifying effects include all deviation from natural development, for example killing, retardation, leaf burn, albinism, dwarfing and the like.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” denotes all generative parts of a plant, for example seeds or vegetative parts of plants such as cuttings and tubers. It includes seeds in the strict sense, as well as roots, fruits, tubers, bulbs, rhizomes, and parts of plants.

The term “safener” as used herein means a chemical that when used in combination with a herbicide reduces the undesirable effects of the herbicide on non-target organisms, for example, a safener protects crops from injury by herbicides but does not prevent the herbicide from killing the weeds.

Crops of useful plants in which the composition according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes. However, the compositions of the present invention are particularly useful in controlling weeds in cotton or soybean crops, especially soybean crops.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides or classes of herbicides (e.g. ALS-, GS-, EPSPS-, PPO-, ACCase- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant varieties commercially available under the trade names RoundupReady® and LibertyLink®. Examples of crops that have been rendered tolerant to PPO inhibiting herbicides by genetic engineering are known in the art, for example as described in WO95/34659. Examples of crops that have been rendered tolerant to HPPD inhibiting herbicides by genetic engineering are known in the art, for example as described in WO2011/063411, WO2011/063413, WO2012/082542, WO2012/082548, WO2010/085705 and WO2011/068567. The compositions of the present invention comprising 2,4-D (or an agrochemically acceptable ester or salt thereof) have potential utility in crops which are have been engineered to tolerate 2,4-D herbicides, for example Enlist™ crops, for example EnlistE3™ Soybeans. The compositions of the present invention comprising dicamba (or an agrochemically acceptable ester or salt thereof) have potential utility in crops which are have been engineered to tolerate dicamba herbicides, for example Roundup Ready 2 Xtend™ Soybeans.

The compositions of the invention can typically be used to control a wide variety of monocotyledonous and dicotyledonous weed species in the crop. The compositions of the present invention provide particular good control of Alopecurus sp. (e.g Alopecurus myosuroides (ALOMY)), Avena sp. Digitaria sp. (e.g Digitaria sanguinalis (DIGSA), Digitaria insularis (TRCIN)), Echinochloa sp. (e.g Echinochloa crus-galli (ECHCG)), Eleusine sp. (e.g Eleusine indica (ELEIN)), Lolium sp., Setaria sp. (e.g Setaria faberi (SETFA)) and Sorghum sp. (e.g Sorghum halepense (SORHA). In all aspects of the invention, in any particular embodiment, the weeds, e.g. to be controlled and/or growth-inhibited, may be monocotyledonous or dicotyledonous weeds, which are tolerant or resistant to one or more herbicides for example, HPPD inhibitor herbicides such as mesotrione, PSII inhibitor herbicides such as atrazine or EPSPS inhibitors such as glyphosate.

Similarly compositions of the invention (which includes those comprising one or more additional pesticide(s)) can further include one or more safeners. In particular, the following safeners are especially preferred: benoxacor, cloquintocet (including cloquintocet-mexyl), cyprosulfamide, dichlormid, fenchlorazole (including fenchlorazole-ethyl), fenclorim, fluxofenim, furilazole, isoxadifen (including isoxadifen-ethyl), mefenpyr (including mefenpyr-diethyl), metcamifen and oxabetrinil.

The compositions of the invention can be applied before or after planting of the crops, before weeds emerge (pre-emergence application) or after weeds emerge (post-emergence application). Where a safener is combined with mixtures of the invention, it is preferred that the mixing ratio of compound of Formula (I) to safener is from 100:1 to 1:10, especially from 20:1 to 1:1.

It is possible that the safener and the compositions of the invention are applied simultaneously. For example, the safener and the composition of the invention might be applied to the locus pre-emergence or might be applied to the crop post-emergence. It is also possible that the safener and the composition of the invention are applied sequentially. For example, the safener might be applied before sowing the seeds as a seed treatment and the composition of the invention might be applied to the locus pre-emergence or might be applied to the crop post-emergence.

The compositions of the invention can advantageously be used in formulations as described, for example, in WO2015/197468.

### BIOLOGICAL EFFICACY

### B1 Post-Emergence Efficacy

The efficacy of various compositions of the present invention were tested against plants including the following species: Amaranthus palmeri (AMAPA), Amaranthus tuberculatus (AMATA), Echinochloa crus-galli (ECHCG) and Sorghum halepense (SORHA). The compositions are applied post-emergence, and the tests evaluated at certain days-after-application (DAA) as indicated. The tests were evaluated (100=total damage to plant; 0=no damage to plant), and the results are shown below in tables B1 to B6.

TABLE B1
Combination of Compound of Formula Ic and B1 (2,4-D).

| | SORHA Sorghum halepense - POST - 17DAA | | | |
|---|---|---|---|---|
| Treatment | Rate g/ha | Observed | Expected | Difference |
| Ic | 12.5 | 73 | | |
| | 25 | 87 | | |
| | 50 | 93 | | |
| | 100 | 98 | | |
| B1 | 250 | 65 | | |
| | 12.5 + 250 | 85 | 73 | 12 |
| | 25 + 250 | 90 | 87 | 3 |
| | 50 + 250 | 98 | 93 | 5 |
| | 100 + 250 | 100 | 98 | 2 |

TABLE B2
Combination of Compound of Formula Ic
and B3g (dicamba dimethylamine salt).

| | AMATA Amaranthus tuberculatus - POST - 20DAA | | | |
|---|---|---|---|---|
| Treatment | Rate g/ha | Observed | Expected | Difference |
| Ic | 12.5 | 5 | | |
| | 25 | 5 | | |
| | 50 | 5 | | |
| | 100 | 5 | | |
| B3g | 250 | 90 | | |
| | 12.5 + 250 | 97 | 91 | 6 |
| | 25 + 250 | 97 | 91 | 6 |
| | 50 + 250 | 95 | 91 | 4 |
| | 100 + 250 | 93 | 91 | 2 |

TABLE B3
Combination of Compound of Formula Ic and B5 (fluroxypyr).

| | AMAPA Amaranthus palmeri - POST - 18DAA | | | |
|---|---|---|---|---|
| Treatment | Rate g/ha | Observed | Expected | Difference |
| Ic | 12.5 | | | |
| | 25 | | | |
| | 50 | | | |
| B5 | 250 | 79 | | |
| | 12.5 + 250 | 83 | 79 | 4 |
| | 25 + 250 | 85 | 79 | 6 |
| | 50 + 250 | 87 | 79 | 8 |

TABLE B4
Combination of Compound of Formula
Ic and halauxifen-methyl (B6a).

| | SORHA—Sorghum halepense - POST - 18DAA | | | |
|---|---|---|---|---|
| Treatment | Rate g/ha | Observed | Expected | Difference |
| Ic | 12.5 | 50 | | |
| | 25 | 87 | | |
| B6a | 250 | 41 | | |
| | 12.5 + 250 | 89 | 70 | 19 |
| | 25 + 250 | 99 | 92 | 7 |

TABLE B5
Combination of Compound of Formula Ic and triclopyr (B7).

| | ECHCG Echinochloa crus-galli - POST - 18DAA | | | |
|---|---|---|---|---|
| Treatment | Rate g/ha | Observed | Expected | Difference |
| Ic | 12.5 | 44 | | |
| | 25 | 65 | | |
| | 50 | 91 | | |
| B7 | 250 | 19 | | |
| | 12.5 + 250 | 64 | 54 | 10 |
| | 25 + 250 | 91 | 72 | 19 |
| | 50 + 250 | 100 | 93 | 7 |

TABLE B6
Combination of Compound of Formula
Ic and florpyrauxifen-benzyl (B4a).

| | ECHCG Echinochloa crus-galli - POST - 15DAA | | | |
|---|---|---|---|---|
| Treatment | Rate g/ha | Observed | Expected | Difference |
| Ic | 12.5 | 66 | | |
| B4a | 4 | 58 | | |
| | 12.5 + 4 | 95 | 85 | 10 |

1. An herbicidal composition comprising (A) a herbicidally effective amount of a compound of Formula (I) 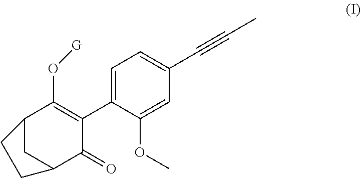
wherein G is selected from the group consisting of hydrogen, —C(O)CH₃ and —C(O)OCH₃; and (B) at least one herbicide selected from the group consisting of 2,4-D, clopyralid, dicamba, florpyrauxifen, fluroxypyr, halauxifen, triclopyr and 4-amino-3-chloro-5-fluoro-6-(7-fluoro-1H-indol-6-yl)pyridine-2-carboxylic acid including agrochemically acceptable esters or salts of any of the aforementioned (B) compounds.

2. An herbicidal composition according to claim 1, wherein the compound of Formula (I) is selected from the group consisting of Formula (Ia), (Ib) and (Ic).

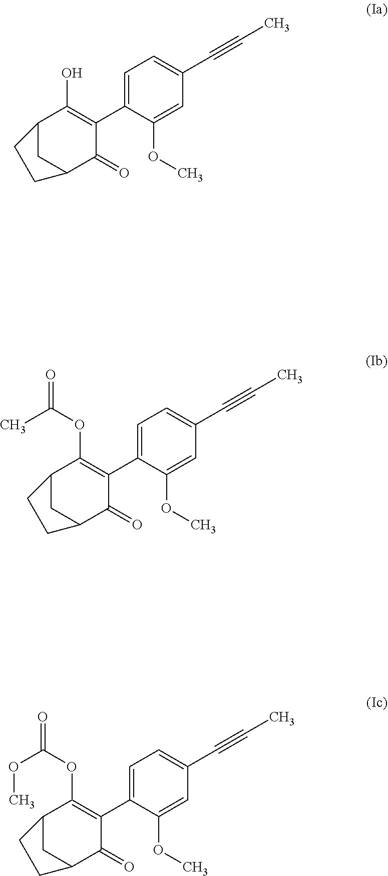

3. An herbicidal composition according to claim 1, wherein the compound of Formula (I) is Formula (Ic).

4. An herbicidal composition according to claim 1, wherein component B is 2,4-D (B1) or an agrochemically acceptable ester or salt thereof.

5. An herbicidal composition according to claim 1, wherein component B is clopyralid (B2).

6. An herbicidal composition according to claim 1, wherein component B is dicamba (B3) or an agrochemically acceptable ester or salt thereof.

7. An herbicidal composition according to claim 1, wherein component B is florpyrauxifen (B4) or florpyrauxifen-benzyl (B4a).

8. An herbicidal composition according to claim 1, wherein component B is fluroxypyr (B5).

9. An herbicidal composition according to claim 1, wherein component B is halauxifen (B6) or halauxifen-methyl (B6a).

10. An herbicidal composition according to claim 1, wherein component B is triclopyr (B7).

11. A herbicidal composition according to claim 1, wherein the composition further comprises an additional herbicidal component (C).

12. An herbicidal composition according to claim 11, wherein component (C) is a herbicide selected from acetochlor, metolachlor, S-metolachlor and pyroxasulfone.

13. A method of controlling weeds at a locus comprising applying to the locus of a weed controlling amount of an herbicidal composition according to claim 1.

14. A method of selectively controlling weeds at a locus comprising crop plants and weeds, said method comprising applying to the locus a weed controlling amount of an herbicidal composition according to claim 1.

15. A method according to claim 14, wherein the crop plant comprises an herbicide tolerance trait.
